(19) United States
(12) Patent Application Publication
(10) Pub. No.: US 2001/0040727 A1
(43) Pub. Date: Nov. 15, 2001

(54) Optical device and zoom binoculars

(75) Inventor: Yasuyuki Aikawa, Kawasaki-shi (JP)

Correspondence Address: Oliff & Berridge PLC, P.O. Box 19928, Alexandria, VA, 22320, US

(73) Assignee: Nikon Corporation

(21) Appl. No.: 09/725,307

(22) Filed: Nov. 29, 2000

(30) Foreign Application Priority Data
Jan. 11, 2000 (JP) 2000-002298

(51) Int. Cl. G02B 23/00

(52) U.S. Cl. 359/407; 359/420

(57) ABSTRACT

An optical device includes: an optical system of which a magnification ratio can be altered; a focusing ring which is actuated in order to set the optical system to a focus position; and a zoom actuation member which is actuated in order to change the magnification ratio of the optical system. And the zoom actuation member is rotated about a support point by actuation force which is applied at an actuation point, and the actuation point is at a position farther removed from the focusing ring, than is the support point.

### INCORPORATION BY REFERENCE

The disclosure of the following priority application is herein incorporated by reference:

Japanese Patent Application No. 2000-2298, filed Jan. 11, 2000.

### BACKGROUND OF THE INVENTION

1. Field of the Invention

The present invention relates to an optical device and to binoculars incorporating a zoom function, of which the magnification ratio can be varied.

2. Description of the Related Art

There is a type of binoculars which incorporates left and right lens bodies and a main body which connects these lens bodies together, with a focusing ring being provided to the main body for focus adjustment. When the observer turns the focusing ring, the distances between objective lenses and eyepiece lenses in the lens bodies can be varied, and thereby it is possible to observe clearly various subjects for observation.

In binoculars furnished with a zoom function which is capable of changing the observation magnification ratio (hereinafter termed zoom binoculars), the main body of the binoculars described above further includes a zoom lever. When the observer actuates the zoom lever while observing a subject for observation, he is able to vary the mutual spacing between several lens groups included in the eyepiece lenses, and thereby, as will be described hereinafter, he can change the observation magnification ratio.

FIG. 4 is a partial sectional view of prior art zoom binoculars as seen from above. In FIG. 4 a top cover is removed and the binoculars are shown as partly cut away in order to view the internal construction. Further, eyepiece lenses 7 and structures surrounding them are shown in sectional view, and a focusing ring 5 and structures surrounding it are shown as exposed. Since the construction of the binoculars is almost symmetrical on the left and right sides of its central axis 4, in the following description, reference numerals will be affixed in the figure to parts on only the one or the other of its sides. A pair of left and right lens bodies 1 and 2 are connected together by a main body 3. The lens bodies 1 and 2 are of the Porro prism type, and objective lenses 8, which are arranged closer together than eyepiece lenses 7, are housed within a front portion of the main body 3.

Generally, each of the eyepiece lenses 7 of the zoom optical system comprises, along its optical axis 10, a first lens group 11 which is termed the front lens, a second lens group 12 which is termed the middle lens, and a third lens group 13 which is termed the rear lens. The front lens 11 and the middle lens 12 are respectively assembled within an front lens frame 14 and a middle lens frame 15. The space between this front lens frame 14 and this middle lens frame 15 is varied so as to be greater for high magnification ratio and smaller for low magnification ratio. This is done by a finger of the user of the binoculars engaging an actuation point 6a of a wiper shaped zoom lever (hereinafter termed a zoom lever) 6 and thereby rotating it in an arcing manner around a support point 6b. The actuation point 6a of the zoom lever 6 is at a position closer to the focusing ring 5 than is the support point 6b. It should be noted that the optical axes 10 and a central axis 4 are parallel.

When the zoom lever 6 is rotated, a zoom cam plate 19 which lies underneath it is rotated around a rotation shaft 19d, and a pair of linking pins 17b and 18b, which are respectively engaged in a pair of cam grooves (not shown in the figure) formed in this cam plate 19, are moved parallel to the central axis 4. The linking pin 17b is fixed to an front lens lever (not shown in the figure) which is linked to the front lens frame 14, while the linking pin 18b is fixed to a middle lens lever (also not shown in the figure) which is linked to the middle lens frame 15. Accordingly, when the zoom lever 6 is rotated, the front lens frame 14 and the middle lens frame 15 can be moved in parallel with the central axis 4, i.e. in parallel with the optical axes 10, while varying the relative distance between them.

The front lens lever and the middle lens lever slide in a pair of left and right parallel grooves 16 which act as guides. The parallel grooves 16 are formed as two-stepped grooves, of which one step portion serves to guide the front lens lever while the other step portion serves to guide the middle lens lever, with the lengths of these grooves being denoted by “l” in the figure. Further, a linking pin which is fixed to the to middle lens lever slides in and is guided by a straight groove 21a which is provided in a cam plate press member 21 which presses against the zoom cam plate 19 from above. The front lens lever and the middle lens lever are enabled to move in straight lines without any play by these guides provided at these three points.

Binoculars are often used outdoors for observing sports events or for bird watching, and it is desirable for zoom operation and focus operation etc. to be possible even when the operator is wearing gloves, in particular when the binoculars are being used in cold weather.

However, with the above described binoculars, since the focusing ring and the actuation point of the zoom lever are positioned close together, there is a danger that, when the operator is turning the focusing ring in order to adjust the focus, his finger may inadvertently come into contact with the actuation point of the zoom lever so as undesirably to change the observation magnification ratio, and also that, conversely, when he is moving the zoom lever in order to change the observation magnification ratio, his finger may inadvertently come into contact with the focusing ring so as undesirably to disturb the focus.

### SUMMARY OF THE INVENTION

The objective of the present invention is to provide an optical device and zoom binoculars which possess enhanced operability, so that, for example, when an operator is turning a focusing ring, his finger does not inadvertently come into contact with the actuation point of a zoom lever, and conversely, when the operator is moving the zoom lever, his finger does not inadvertently come into contact with the focusing ring.

In order to attain the above object, an optical device according to the present invention comprises: an optical system of which a magnification ratio can be altered; a focusing ring which is actuated in order to set the optical system to a focus position; and a zoom actuation member which is actuated in order to change the magnification ratio of the optical system. And the zoom actuation member is rotated about a support point by actuation force which is applied at an actuation point, and the actuation point is at a position farther removed from the focusing ring, than is the support point.

Zoom binoculars according to the present invention comprises: left and right lens bodies; a main body which is positioned between the left and right lens bodies; a focusing ring provided to the main body, which is actuated for focusing; and a zoom actuation member provided to the main body in a vicinity of the focusing ring, which is actuated in order to change an observation magnification ratio of the zoom binoculars. And the zoom actuation member is rotated about a support point by actuation force which is applied at an actuation point, and the actuation point is at a position farther removed from the focusing ring, than is the support point.

In this zoom binoculars, it is preferred that the zoom actuation member is positioned more towards eyepiece lenses of the left and right lens bodies, than is the focusing ring.

Also, it is preferred that the focusing ring and the zoom actuation member are provided in sequence along a direction of optical axes of eyepiece lenses of the left and right lens bodies.

### BRIEF DESCRIPTION OF THE DRAWINGS

FIG. 1 is a partial sectional view of zoom binoculars according to the preferred embodiment of the present invention as seen from above.

FIG. 2 is a plan view showing the main body structure of this zoom binoculars according to the preferred embodiment of the present invention.

FIG. 3A is a plan view showing the main body structure of the zoom binoculars according to the preferred embodiment of the present invention.

FIG. 3B is a sectional view taken along the line A-A viewing in the direction of the arrows in FIG. 3A.

FIG. 4 is a partial sectional view of prior art zoom binoculars as seen from above.

### DESCRIPTION OF THE PREFERRED EMBODIMENT

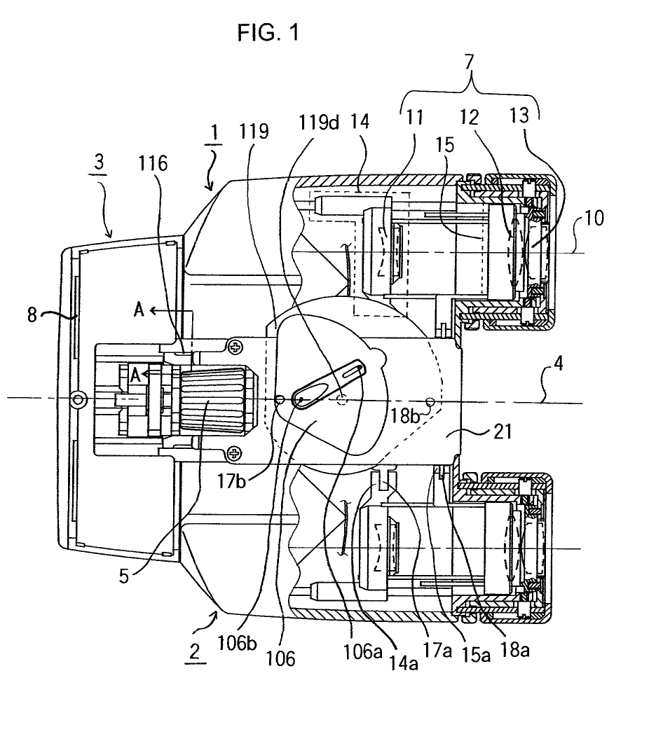

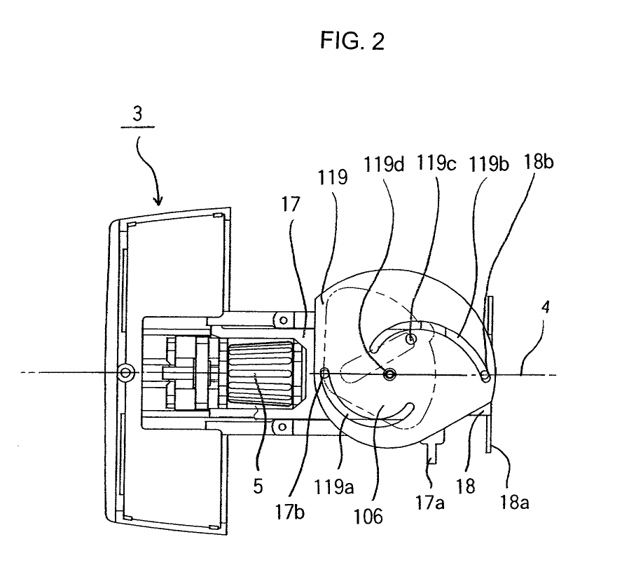

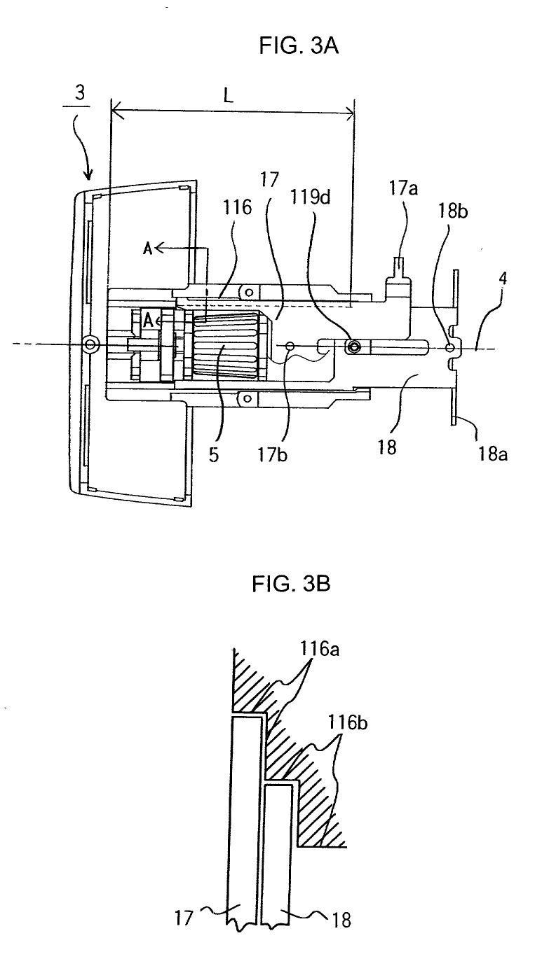

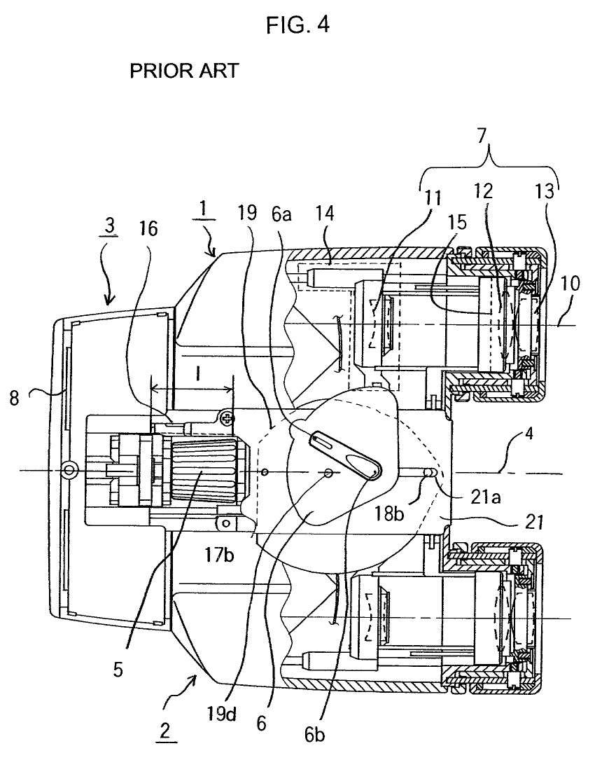

FIGS. 1 through 3 show zoom binoculars according to the preferred embodiment of the present invention. FIG. 1 is a partial sectional view of the zoom binoculars as seen from above, and corresponds to FIG. 4 relating to the prior art. FIG. 2 is a plan view, showing a central portion of the main body of the zoom binoculars with a zoom lever and a cam plate press member removed therefrom. Moreover, FIG. 3A is a plan view of this central portion of the main body of the zoom binoculars, with a zoom cam plate (which is one of the elements shown in FIG. 2) further removed. And FIG. 3B is a sectional view of parallel grooves 116 taken along the line A-A viewing in the direction of the arrows in FIG. 1 and FIG. 3A. In these figures and in the following explanation, for parts which correspond to parts of the prior art structure shown in FIG. 4, the same reference symbols are employed.

With this zoom binoculars according to the preferred embodiment, just as with the zoom binoculars of FIG. 4, a pair of left and right lens bodies 1 and 2 are connected together by a main body 3. The lens bodies 1 and 2 are of the Porro prism type, and objective lenses 8, which are arranged closer together than eyepiece lenses 7, are housed within a front portion of the main body 3.

Each of the eyepiece lenses 7 of the zoom optical system comprises, along its optical axis 10, a first lens group 11 which is termed the front lens, a second lens group 12 which is termed the middle lens, and a third lens group 13 which is termed the rear lens. The front lens 11 and the middle lens 12 are respectively assembled within an front lens frame 14 and a middle lens frame 15. The space between this front lens frame 14 and this middle lens frame 15 is varied so as to be greater for high magnification ratio and smaller for low magnification ratio. This is done by a finger of the user of the binoculars engaging an actuation point 106a of a wiper shaped zoom lever (hereinafter termed a zoom lever) 106 and thereby rotating it in an arcing manner around a support point 106b. The actuation point 106a of the zoom lever 106 is at a position further from a focusing ring 5 than is the support point 106b. It should be noted that the optical axes 10 and a central axis 4 are parallel.

When the zoom lever 106 is rotated, a zoom cam plate 119 which lies underneath it is rotated around a rotation shaft 119d, and a pair of linking pins 17b and 18b, which are respectively engaged in a pair of cam grooves 119a and 119b formed in this cam plate 119 (see FIG. 2), are moved parallel to the central axis 4. The linking pin 17b is fixed to an front lens lever 17 which is linked to the front lens frame 14, while the linking pin 18b is fixed to a middle lens lever 18 which is linked to the middle lens frame 15. Accordingly, when the zoom lever 106 is rotated, the front lens frame 14 and the middle lens frame 15 can be moved in parallel with the central axis 4, i.e. in parallel with the optical axes 10, while varying the relative distance between them.

When zooming, the front lens frame 14 and the middle lens frame 15 should be moved as described above in parallel with the optical axes 10 while varying the relative distance between them. As shown in FIG. 1, notched portions 14a are fixedly provided to the front lens frame 14, extending inwards towards the central axis 4. Further, claw portions (projections) 17a are fixedly provided to the front lens lever 17, extending outward from the central axis 4. These claw portions 17a are engaged into these notched portions 14a, and thereby, when the front lens lever 17 slides along parallel grooves 116 (described hereinafter) which are provided in the main body 3, the front lens frame 14 also move.

On the other hand, in a similar manner, notched portions 15a are fixedly provided to the middle lens frame 15, extending inwards towards the central axis 4. Further, claw portions 18a are fixedly provided to the middle lens lever 18, extending outward from the central axis 4. These claw portions 18a are engaged into these notched portions 15a, and thereby, when the middle lens lever 18 slides along the parallel grooves 116 described hereinafter, the middle lens frame 15 also move.

As shown in FIG. 3A, the front lens linking pin 17b is fixed in the front lens lever 17, while the middle lens linking pin 18b is fixed in the middle lens lever 18.

As shown in FIG. 2, the front lens linking pin 17b is engaged into a cam groove 119a which is formed in the zoom cam plate 119, while the middle lens linking pin 18b is engaged into a cam groove 119b which is also formed therein. Further, a pin 119c which is fixed in the zoom cam plate 119 is inserted into a slot (not shown) which is provided in the vicinity of the actuation point 106a of the zoom lever 106. When the zoom lever 106 is rotated, the pin 119c also rotates in the same direction, and thereby the zoom cam plate 119 rotates around the rotation shaft 119d, so that the front lens linking pin 17b and the middle lens linking pin 18b are moved in parallel with the central axis 4.

FIG. 3B is a partial sectional view for showing the structure of the parallel grooves 116, and is a sectional view of the parallel grooves 116 taken along the line A-A viewing in the direction of the arrows in FIG. 1 and FIG. 3A. As shown in FIG. 3B, the parallel grooves 116 are made as two-stepped grooves. One groove step portion 116a serves to guide the front lens lever 17, while the other groove step portion 116b serves to guide the middle lens lever 18. Further, the parallel grooves 116 are made of length L, where the length L is longer than the length 1 of the parallel grooves in the prior art binoculars shown in FIG. 4. Since the grooves 116 are elongated in this manner, a sufficient stroke is ensured for the middle lens lever 18 when zooming is being performed, and sliding without play is possible even though the straight groove 21a shown in FIG. 4 is not present.

A first distinguishing feature of this preferred embodiment, as shown in FIGS. 1 and 2, is that the positional relationship of the actuation point 106a and the support point 106b of the zoom lever 106 is the reverse of that shown in FIG. 4. Due to this, unintentional change of the observation magnification ratio when the operator of the binoculars is turning the focusing ring to adjust the focus and his finger accidentally contacts the actuation point of the zoom lever, and disturbance of the focus when he is changing the observation magnification ratio by moving the zoom lever and his finger accidentally contacts the focusing ring, are both prevented.

A second distinguishing feature of this preferred embodiment is that, along with the omission of the straight groove 21a, the parallel grooves 116 are made longer than the grooves of the FIG. 4 prior art construction, both towards the eyepiece lenses and towards the objective lenses. In other words, the parallel grooves 116 are made longer so that sliding without any play is possible even without any straight groove.

Namely, the actuation point 106a of the zoom lever 106 is positioned far away from the focusing ring 5, and further the guide function of the front lens lever 17 and the middle lens lever 18 is entirely implemented by the parallel grooves 116. By doing this, a sufficient stroke for the middle lens lever 18 when zoom operation is performed is ensured, and sliding without any play is possible even without any straight groove.

It should be understood that, although in the above by way of example the present invention has been described with reference to a preferred embodiment which is zoom binoculars, it is not necessarily limited to this application. The present invention can also be applied to any optical system (optical device) in which there are included in near proximity to one another a focusing ring which is operated in order to adjust the focus, and a zoom lever which is adjusted in order to vary the observation magnification ratio. In this case, if the direction of actuation of the focusing ring and the direction of actuation of the zoom lever are the same, the benefits of the present invention are even more apparent.

What is claimed is:

1. An optical device, comprising:
an optical system of which a magnification ratio can be altered;
a focusing ring which is actuated in order to set said optical system to a focus position; and
a zoom actuation member which is actuated in order to change the magnification ratio of said optical system, wherein
said zoom actuation member is rotated about a support point by actuation force which is applied at an actuation point, and said actuation point is at a position farther removed from said focusing ring, than is said support point.

2. Zoom binoculars, comprising:
left and right lens bodies;
a main body which is positioned between said left and right lens bodies;
a focusing ring provided to said main body, which is actuated for focusing; and
a zoom actuation member provided to said main body in a vicinity of said focusing ring, which is actuated in order to change an observation magnification ratio of the zoom binoculars, wherein
said zoom actuation member is rotated about a support point by actuation force which is applied at an actuation point, and said actuation point is at a position farther removed from said focusing ring, than is said support point.

3. Zoom binoculars according to claim 2, wherein said zoom actuation member is positioned more towards eyepiece lenses of said left and right lens bodies, than is said focusing ring.

4. Zoom binoculars according to claim 2, wherein said focusing ring and said zoom actuation member are provided in sequence along a direction of optical axes of eyepiece lenses of said left and right lens bodies.
